(19) United States
(12) Patent Application Publication
(10) Pub. No.: US 2020/0122479 A1
(43) Pub. Date: Apr. 23, 2020

(54) HEAT TRANSFER PRINTER AND PRINTING CONTROL METHOD

(71) Applicant: Mitsubishi Electric Corporation, Tokyo (JP)

(72) Inventor: Shiohiro OKINAKA, Tokyo (JP)

(73) Assignee: Mitsubishi Electric Corporation, Tokyo (JP)

(21) Appl. No.: 16/607,037

(22) PCT Filed: Jul. 5, 2017
(86) PCT No.: PCT/JP2017/024669

§ 371 Date: Oct. 21, 2019

(51) Int. Cl. B41J 2/355

(52) U.S. Cl. CPC B41J 2/355

(57) ABSTRACT

A heat transfer printer performs gradation control processing for forming a first end portion and a second end portion Gbe on paper. In the gradation control processing, first heat treatment and second heat treatment are performed. Moreover, in the first heat treatment, a thermal head emits heat so that a contour of color generation by an ink sheet on a first rear end side of the first end portion is aligned parallel to a main scanning direction. In the second heat treatment, the thermal head emits the heat so that a contour of the color generation by the ink sheet on a second leading end side of the second end portion is aligned parallel to the main scanning direction.

### TECHNICAL FIELD

The present invention relates to a heat transfer printer having a function of printing an elongated image, utilizing two or more images, and a printing control method.

### BACKGROUND ART

In recent years, scenes have been increasing where in a heat transfer printer, panorama printing in which an elongated image is printed, utilizing at least two images is performed. In order to perform the panorama printing, first, for example, two images are acquired from an elongated image. The two images are printed so that the two images are connected, by which the panorama printing is implemented. In Patent Documents 1, 2, there have been disclosed techniques in each of which a leading end portion of a second image is overlapped on a rear end portion of a first image to thereby print an elongated image.

In Patent Document 1, a configuration has been disclosed, in which in an overlapping region where the leading end portion of the second image is overlapped on the rear end portion of the first image, a border line of the two images is made inconspicuous (hereinafter, also referred to as a “related configuration A”).

Specifically, in the related configuration A, a density of the rear end portion of the first image gradually decreases from a leading end toward a rear end of the rear end portion. Moreover, a density of the leading end portion of the second image gradually increases from a leading end toward a rear end of the leading end portion. This allows an image print density in the overlapping region to be adjusted. The image print is an image printed on paper. Moreover, in the related configuration A, a technique has been also disclosed in which image processing using a dither method is performed to the overlapping region.

Moreover, in Patent Document 2, a configuration has been disclosed in which changes of colors in the overlapping region of the two images are cancelled out (hereinafter, referred to as a “related configuration B”). Specifically, in a related configuration B, color values in the overlapping region are converted, using a color conversion coefficient group prepared in advanced. This reduces the changes of colors in the overlapping region.

### PRIOR ART DOCUMENTS

### Patent Documents

Patent Document 1: Japanese Patent Application Laid-Open No. 2004-082610
Patent Document 2: Japanese Patent Application Laid-Open No. 2016-182783

### SUMMARY

### Problem to be Solved by the Invention

In the heat transfer printer, a thermal energy that a thermal head gives dyes (inks) differs, depending on a type of density of a pixel in an image to be printed. For example, as the density of the pixel becomes lower, a required thermal energy becomes smaller. As the thermal energy becomes smaller, a location where the pixel generates a color is more easily shifted from a desired location on paper.

Therefore, in some types of density of a plurality of pixels configuring a contour of the end portion (overlapping region) of the image, a phenomenon that the contour is shown as a curve line on paper may occur. If the phenomenon occurs, there is a problem that quality of a joint portion (overlapping region) of the two images becomes low.

Consequently, it is required that regardless of the densities of the plurality of pixels configuring the contour of the end portion of the image, the contour is shown on the paper as a straight line along a main scanning direction. In the related configurations A, B, this request cannot be satisfied.

The present invention is achieved to solve the above-described problem, and an object thereof is to provide a heat transfer printer that realizes that contours of end portions of images are shown as straight lines along a main scanning direction regardless of densities of a plurality of pixels configuring the contours, or the like.

### Means to Solve the Problem

In order to achieve the above-described object, a heat transfer printer according to one aspect of the present invention forms a synthetic image expressed by a first image and a second image on paper by a thermal head heating an ink sheet. The synthetic image has an overlapping region where a second end portion overlaps a first end portion, the first end portion being a rear end portion of the first image, and the second end portion being a leading end portion of the second image, the first end portion has a first leading end and a first rear end, the first leading end corresponding to a leading end of the overlapping region, and the first rear end being a rear end of the first image, the second end portion has a second leading end and a second rear end, the second leading end being a leading end of the second image, and the second rear end corresponding to a rear end of the overlapping region, the heat transfer printer includes the thermal head that emits heat, the heat transfer printer performs gradation control processing for forming the first end portion and the second end portion on the paper, in the gradation control processing, first heat treatment and second heat treatment are performed, in the first heat treatment, the thermal head emits heat so that a density of the first end portion gradually decreases from the first leading end toward the first rear end, and that a contour of color generation by the ink sheet on a first rear end side of the first end portion is aligned parallel to a main scanning direction, and in the second heat treatment, the thermal head emits the heat so that a density of the second end portion gradually increases from the second leading end toward the second rear end, and that a contour of the color generation by the ink sheet on a second leading end side of the second end portion is aligned parallel to the main scanning direction.

### Effects of the Invention

According to the present invention, in the first heat treatment, the thermal head emits the heat so that the contour of the color generation by the ink sheet on the first rear end side of the first end portion is aligned parallel to the main scanning direction. That is, in the first heat treatment, the thermal head emits the heat so that the contour on the first rear end side of the first end portion is shown as a straight line along the main scanning direction on the paper.

Moreover, in the second heat treatment, the thermal head emits the heat so that the contour of the color generation by the ink sheet on the second leading end side of the second end portion is aligned parallel to the main scanning direction. That is, in the second heat treatment, the thermal head emits the heat so that the contour on the second leading end side of the second end portion is shown as a straight line along the main scanning direction on the paper.

This allows it to be realized that the contours to be shown on the paper as the straight lines along the main scanning direction regardless of the densities of the plurality of pixels configuring the contours of the end portions of the images.

The objects, features, aspects, and advantages of the present invention will become more apparent from the following detailed description and the accompanying drawings.

### BRIEF DESCRIPTION OF DRAWINGS

FIG. 1 is a block diagram showing a main configuration of a heat transfer printer according to a first embodiment of the present invention.

FIG. 2 is a diagram mainly showing a configuration to perform image print in the heat transfer printer according to the first embodiment of the present invention.

FIG. 3 is a diagram for describing an ink sheet.

FIGS. 4A, 4B, and 4C are diagrams for describing panorama printing.

FIG. 5 is a flowchart of the panorama printing processing according to the first embodiment of the present invention.

FIG. 6 is a diagram showing one example of a correction table.

FIG. 7 is a diagram showing one example of another correction table.

FIGS. 8A, 8B, and 8C are diagrams for describing a state where an image is printed.

FIGS. 9A, 9B, and 9C are diagrams for describing a state where an image is printed.

FIGS. 10A and 10B are diagrams for describing characteristics regarding thermal energy.

FIG. 11 is a diagram for describing the characteristics regarding the thermal energy.

FIG. 12 is a flowchart of panorama printing processing A according to a second embodiment of the present invention.

FIG. 13 is a diagram for describing adjustment of hue.

FIG. 14 is a diagram showing a line used for adjustment of density.

FIG. 15 is a flowchart of panorama printing processing B according to a third embodiment of the present invention.

FIG. 16 is a diagram showing lines used for the adjustment of the density.

FIG. 17 is a block diagram showing a characteristic functional configuration of a heat transfer printer.

### DESCRIPTION OF EMBODIMENTS

Hereinafter, referring to the drawings, embodiments of the present invention will be described. In the following drawings, the same components are denoted by the same reference signs. Names and functions of the components denoted by the same reference signs are the same. Therefore, detailed description of a part of each of the components denoted by the same reference signs may be omitted.

It should be noted that dimensions, a material, a shape of each of the components exemplified in the embodiments, relative arrangement of the components and the like may be appropriately changed according to a configuration of an apparatus to which the present invention is applied, various conditions, and the like.

### First Embodiment

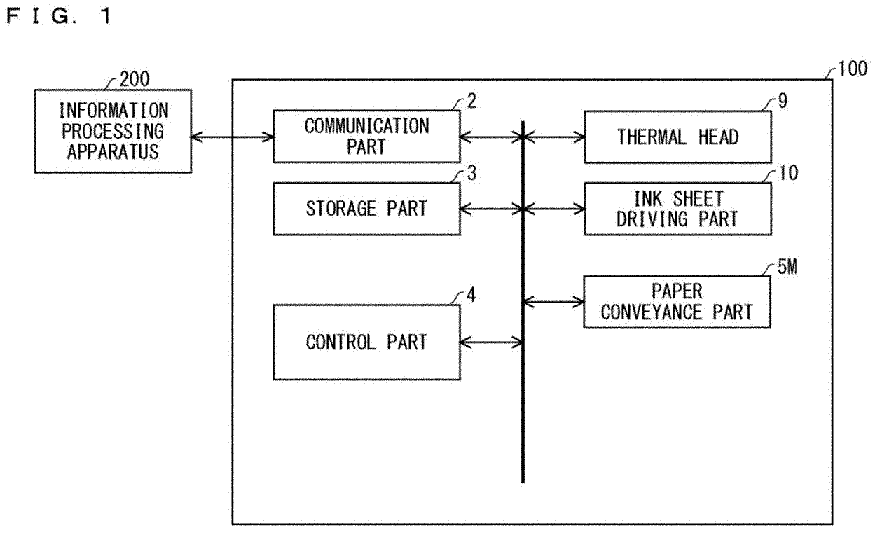

FIG. 1 is a block diagram showing a main configuration of a heat transfer printer 100 according to a first embodiment of the present invention. In FIG. 1, for description, an information processing apparatus 200 not included in the heat transfer printer 100 is also shown. In the following description, printing an image on paper is also referred to as an “image print”. As described before, the image print is also an image printed on paper. The heat transfer printer 100 performs image print processing P for printing an image on paper, details of which will be described later.

The information processing apparatus 200 is an apparatus that controls the heat transfer printer 100. The information processing apparatus 200 is, for example, a Personal Computer (PC). The information processing apparatus 200 is operated by a user. When the user performs an image print executing operation to the information processing apparatus 200, the information processing apparatus 200 transmits an image print instruction and image data D1 to the heat transfer printer 100. The image print executing operation is an operation for causing the heat transfer printer 100 to execute the image print processing P. Moreover, the image print instruction is an instruction for causing the heat transfer printer 100 to execute the image print processing P. The image data D1 is data of an image to be printed on paper.

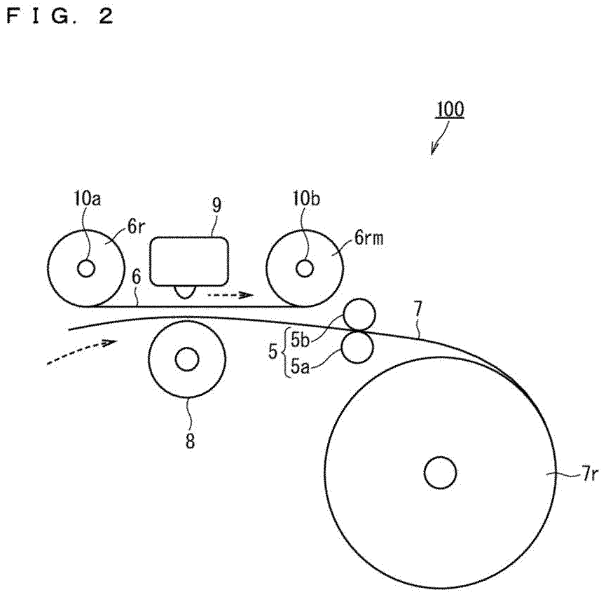

FIG. 2 is a diagram mainly showing a configuration to perform the image print in the heat transfer printer 100 according to the first embodiment of the present invention. FIGS. 1 and 2, a component not related to the present invention (e.g., a power supply) is not shown. FIG. 2 shows a state where roll paper 7r and an ink sheet 6 are attached to the heat transfer printer 100. The roll paper 7r is configured by elongated paper 7 wound into a roll shape. The paper 7 has a receiving layer.

The ink sheet 6 is an elongated sheet. An ink roll 6r is configured by winding an end portion on one side of the ink sheet 6 into a roll shape. The ink roll 6r is mounted on a reel 10a described later. An ink roll 6rm is configured by winding an end portion on another side of the ink sheet 6 into a roll shape. The ink roll 6rm is mounted on a reel 10b described later.

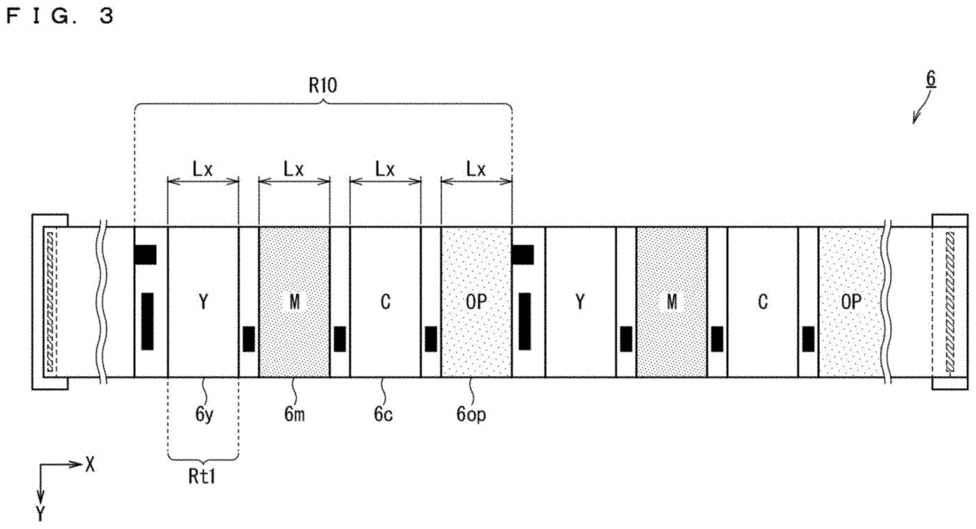

FIG. 3 is a diagram for describing the ink sheet 6. In FIG. 3, an X direction and a Y direction are orthogonal to each other. The X direction and the Y direction shown in the following figures are also orthogonal to each other. In the following description, a direction including the X direction and a direction opposite to the X direction (−X direction) is also referred to as an “X axis direction”. Moreover, in the following description, a direction including the Y direction and a direction opposite to the Y direction (−Y direction) is also referred to as a “Y axis direction”. In the following description, a plane including an X axis direction and a Y axis direction is also referred to as an “XY plane”.

Referring to FIGS. 1, 2, and 3, the heat transfer printer 100 includes a communication part 2, a storage part 3, a control part 4, a conveyance roller pair 5, a paper conveyance part 5M, a platen roller 8, a thermal head 9, and an ink sheet driving part 10.

The communication part 2 has a function of communicating with the information processing apparatus 200. The image print instruction and the image data D1 transmitted by the information processing apparatus 200 are transmitted to the control part 4 through the communication part 2.

The storage part 3 is a memory that stores various types of data, programs and the like. The storage part 3 is configured of, for example, a volatile memory and a non-volatile memory. The volatile memory is a memory that temporarily stores the data. The volatile memory is, for example, a RAM. In the non-volatile memory are stored a control program, an initial setting value, and the like.

The control part 4 performs various types of processing to each of the parts of the heat transfer printer 100, details of which will be described later. The control part 4 controls, for example, the thermal head 9. The control part 4 performs the various types of processing in accordance with a control program. The control part 4 is, for example, a processor such as a Central Processing Unit (CPU) or the like. The control part 4 accesses the storage part 3 to read the data or the like stored in the storage part 3 as needed. Moreover, the control part 4 performs processing for converting image data to image print data, or the like.

The thermal head 9 has a function of emitting heat. The thermal head 9 emits the heat in accordance with control of the control part 4, details of which will be described later.

The conveyance roller pair 5 is a roller pair for conveying the paper 7. The conveyance roller pair 5 is configured of a grip roller 5a and a pinch roller 5b. The grip roller 5a rotates, accompanying driving of the paper conveyance part 5M. The paper conveyance part 5M is, for example, a motor.

The platen roller 8 is provided so as to be opposed to a part of the thermal head 9. The platen roller 8 is movably configured of a driving part not shown. The platen roller 8 comes into contact with the thermal head 9 with the paper 7 and the ink sheet 6 interposed.

In the following description, a state of the platen roller 8 when the platen roller 8 is in contact with the thermal head 9 with the paper 7 and the ink sheet 6 interposed is also referred to as a “platen contact state”. The platen contact state is a state where the paper 7 and the ink sheet 6 are sandwiched by the platen roller 8 and the thermal head 9.

In the platen contact state, the thermal head 9 heats the ink sheet 6, by which dyes (inks) of the ink sheet 6 are transferred to the paper 7.

The ink sheet driving part 10 has a function of rotating the reel 10b. The reel 10b rotates so that the ink roll 6rm winds the ink sheet 6. The reel 10a rotates, accompanying the rotation of the reel 10b. The reel 10a rotates so that the ink sheet 6 is supplied from the ink roll 6r.

Referring to FIG. 3, in the ink sheet 6, an ink region R10 is arranged periodically along a longitudinal direction (X axis direction) of the ink sheet 6.

In the ink region R10, dyes 6y, 6m, 6c, and a protection material 6op are provided. Each of the dyes 6y, 6m, 6c, and the protection material 6op is a transfer material to be transferred to the paper 7 by being heated by the thermal head 9. Each of the dyes 6y, 6m, 6c denotes a color to be transferred to the paper 7. The dyes 6y, 6m, 6c denote colors of yellow, magenta, and cyan, respectively. In the following description, yellow, magenta, and cyan are also referred to as “Y”, “M”, and “C”, respectively. Moreover, in the following description, each of the dye of Y, the dye of M, and the dye of C is also referred to as a “color dye”.

The protection material 6op is a material for protecting the colors transferred to the paper 7 (overcoat). Specifically, the protection material 6op is a material for protecting an image formed on the paper 7 by the dyes 6y, 6m, 6c. In the following description, the protection material 6op is also referred to as an “OP material”. Moreover, in the following description, a region for forming the image in the paper 7 is also referred to as an “image print region”.

In the image print processing P, unit image print processing is performed. In the unit image print processing, in the platen contact state, while the thermal head 9 is heating the transfer material of the ink sheet 6, the ink sheet 6 and the paper 7 are conveyed simultaneously. This allows the transfer material to be transferred to the image print region of the paper 7 on one line basis.

The above-described unit image print processing is repeatedly performed to each of the dyes 6y, 6m, 6c, and the protection material 6op, which are the transfer materials, by which the dyes 6y, 6m, 6c, and the protection material 6op are transferred to the image print region of the paper 7 in order of the dyes 6y, 6m, 6c, and the protection material 6op. As a result, the image is formed in the image print region of the paper 7, and the image is protected by the protection material 6op. This increases lightfast of the image, fingerprint resistance of the image, and the like.

In the following description, the image formed in the image print region of the paper 7 is also referred to as an “image Gn”. Moreover, in the following description, a direction where the paper 7 is conveyed is also referred to as a “paper conveyance direction”. In FIG. 3, the paper conveyance direction is the X axis direction.

As directions for the heat transfer printer 100 to form the image on the paper, there exist a main scanning direction and a sub-scanning direction. The sub-scanning direction is the paper conveyance direction. Moreover, the main scanning direction is a direction perpendicular to the sub-scanning direction.

In the following description, a region where each of the dyes 6y, 6m, 6c, and the protection material 6op is provided in the ink sheet 6 is also referred to as a “material region Rt1”. Moreover, in the following description, a length of the material region Rt1 in the sub-scanning direction (X axis direction) is also referred to as a “length Lx” or “Lx”. A size of the material region Rt1 corresponds to a size of one screen corresponding to the image Gn.

The length Lx is decided in advance for a reason of manufacturing of the ink sheet 6. Therefore, when the above-described ink sheet 6 is used, an upper limit of the length of the image Gn in the sub-scanning direction is the length Lx. In the following description, the length of the image Gn in the sub-scanning direction is also referred to as an “image print size”.

Normally, in order to print an image having a longer size than the length Lx, a new ink sheet needs to be designed and manufactured. Moreover, a labor for exchanging the ink sheet attached to the heat transfer printer in accordance with the image print size is also needed. This causes a high cost of the ink sheet, complication and the like.

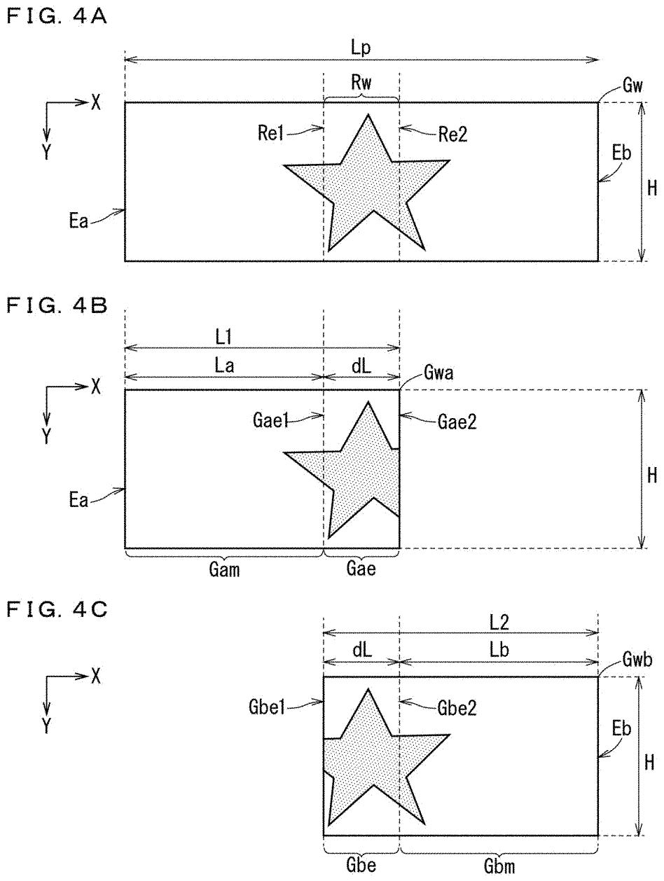

Consequently, it can be considered that the foregoing panorama printing is performed FIGS. 4A, 4B, and 4C are diagrams for describing the panorama printing. In the following description, an image to be subjected to the panorama printing is also referred to as a “panorama image Gw”. In FIGS. 4A, 4B, and 4C, the main scanning direction is the Y axis direction, and the sub-scanning direction is the X axis direction.

FIG. 4A is a diagram showing one example of the panorama image Gw. The panorama image Gw has ends Ea, Eb. In the following description, a length of the panorama image Gw in the main scanning direction is also referred to as a “length H” or “H”. Moreover, in the following description, a length of the panorama image Gw in the sub-scanning direction is also referred to as a “length Lp” or “Lp”. A size of the panorama image Gw is H×Lp.

The panorama image Gw is configured of a plurality of pixels. Each of the pixels is expressed by a gradation value (pixel value) indicating a density. In the following description, data indicating the gradation value (pixel value) of the pixel is also referred to as “gradation data” or “pixel data”. Moreover, in the following description, a highest density that the pixel can express is also referred to a “highest density”. Moreover, in the following description, a lowest density that the pixel can express is also referred to a “lowest density”.

In the present embodiment, the gradation value (pixel value) of the pixel of the image is expressed in 8 bits as one example. In this case, the value of the gradation data is set to a value in a range of 0 to 255. In the following description, the gradation value corresponding to the lowest density is also referred to as a “lowest density value”. The lowest density value is, for example, 255. Moreover, in the following description, the gradation value corresponding to the highest density is also referred to as a “highest density value”. The highest density value is, for example, 0.

For example, if the gradation data indicates 0, the density of the pixel corresponding to the gradation data is the highest density. Moreover, for example, if the gradation data indicates 255, the density of the pixel corresponding to the gradation data is the lowest density.

The gradation value of the pixel is not limited to the expression of 8 bits. The gradation value of the pixel may be expressed, for example, in 10 bits.

In the present embodiment, in order to make description easy to understand, an example will be described in which the panorama printing is performed, using two images. In the following description, the two images used for generating the panorama image Gw are also referred to as “images Gwa, Gwb”. Although details will be described later, the panorama image Gw is a synthetic image expressed by the images Gwa, Gwb. The images Gwa, Gwb are formed (printed) on the paper 7 in order of the images Gwa, Gwb. Although details will be described later, the heat transfer printer 100 forms the panorama image Gw on the paper 7 by the thermal head 9 heating the ink sheet 6.

FIG. 4B shows one example of the image Gwa. The image Gwa is an image from a central portion to the end Ea of the panorama image Gw in the panorama image Gw. The image Gwa has an image Gam and an end portion Gae. The end portion Gae is a rear end portion of the image Gwa. The end portion Gae has a leading end Gae1 and a rear end Gae2. The rear end Gae2 is a rear end of the image Gwa.

FIG. 4C shows one example of the image Gwb. The image Gwb is an image from the central portion to the end Eb of the panorama image Gw in the panorama image Gw. The image Gwb has an end portion Gbe and an image Gbm. The end portion Gbe is a leading end portion of the image Gwb The end portion Gbe has a leading end Gbe1 and a rear end Gbe2. The leading end Gbe1 is a leading end of the image Gwb.

Moreover, the panorama image Gw has an overlapping region Rw. The overlapping region Rw is a region where the end portion Gbe of the image Gwb overlaps the end portion Gae of the image Gwa.

A shape of the overlapping region Rw is rectangular. The overlapping region Rw has a leading end Re1 and a rear end Re2. The leading end Gae1 of the end portion Gae corresponds to the leading end Re1 of the overlapping region Rw. The rear end Gbe2 of the end portion Gbe corresponds to the rear end Re2 of the overlapping region Rw. In the following description, a length of the overlapping region Rw in the sub-scanning direction is also referred to as a “length dL” or “dL”.

The overlapping region Rw has a plurality of pixels arranged in matrix. A plurality of pixels arranged in the overlapping region Rw configure a matrix of m rows and n columns. Each of m and n is an integer of two or more. That is, the overlapping region Rw has m rows and n lines (columns). In the overlapping region Rw, a number of pixels aligned in the sub-scanning direction is n. In each of the lines, m pixels are arranged. A number of the pixels included in the overlapping region Rw is k (an integer of two or more). “k” is a number calculated in an expression of m×n.

In the following description, a length of the image Gwa in the sub-scanning direction is also referred to as a “length L1” or “L1”. Moreover, in the following description, a length of the image Gam in the sub-scanning direction is also referred to as a “length La” or “La”. The length L1 is La+dL. A size of the image Gwa is H×L1. As to L1, a relational expression of L1<Lx is established.

Moreover, in the following description, a length of the image Gwb in the sub-scanning direction is also referred to as a “length L2” or “L2”. Moreover, in the following description, a length of the image Gbm in the sub-scanning direction is also referred to as a “length Lb” or “Lb”. The length L2 is Lb+dL. A size of the image Gwb is H×L2. As to L2, a relational expression of L2<Lx is established. The length LP of the panorama image Gw is expressed by the following expression 1.

[Expression 1]

Lp=L1+L2−d_{L} (1)

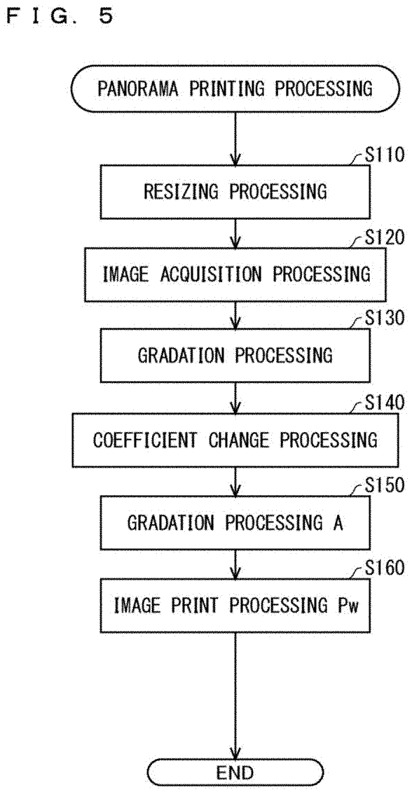

Next, processing for performing the panorama printing (hereinafter, also referred to as “panorama printing processing”) will be described. FIG. 5 is a flowchart of the panorama printing processing according to the first embodiment of the present invention. In the present embodiment, in order to make the processing easy to understand, processing in the case where the panorama image Gw is formed using the two images will be described. The two images are, as one example, the image Gwa in FIG. 4B and the image Gwb in FIG. 4C. In the following description, an image to be printed is also referred to as an “object image”.

In the panorama printing processing, the processing in steps S110 to S140 corresponds to preprocessing for performing steps S150, S160.

In the panorama printing processing, first, processing in step S110 is performed. In step S110, resizing processing is performed. In the resizing processing, the control part 4 changes a size of the object image so that the size of the object image becomes H×Lp. An image obtained by the resizing processing is the panorama image Gw in FIG. 4A as one example.

If the size of the object image is H×Lp, the change of the size of the object image is not performed. In this case, the object image is, for example, the panorama image Gw in FIG. 4A. In the following description, an image that can be formed by a single image print processing P is also referred to as a “unit image”.

In step S120, image acquisition processing is performed. In the image acquisition processing, the control part 4 acquires the image Gwa in FIG. 4B and the image Gwb in FIG. 4C from the panorama image Gw as the unit images.

As described before, the size of the image Gwa is H×L1. L1 is La+dL. Moreover, as to L1, the relational expression of L1<Lx is established. The size of the image Gwb is H×L2. L2 is Lb+dL. Moreover, as to L2, the relational expression of L2<Lx is established.

In the following description, an image the density of which gradually changes in the sub-scanning direction is also referred to as a “gradation image”. Moreover, in the following description, the end portion Gae in which the density of the end portion Gae gradually decreases from the leading end Gae1 toward the rear end Gae2 of the end portion Gae is also referred to an “end portion Gar”. The end portion Gar is a gradation image. Moreover, in the following description, the end portion Gbe in which the density of the end portion Gbe gradually increases from the leading end Gbe1 of the end portion Gbe toward the rear end Gbe2 of the end portion Gbe is also referred to an “end portion Gbr”. The end portion Gbr is a gradation image.

In step S130, gradation processing for generating the gradation image is performed. In the gradation processing, the control part 4 corrects the densities (gradation values) of a plurality of pixels included in the end portion Gae so that the end portion Gae of the image Gwa makes into the end portion Gar (gradation image). Moreover, the control part 4 corrects the densities (gradation values) of a plurality of pixels included in the end portion Gbe so that the end portion Gbe of the image Gwb makes the end portion Gbr (gradation image).

In the following description, processing for correcting the gradation values is also referred to as “gradation correction processing”. Specifically, in the gradation processing, the gradation correction processing is performed to each of the end portion Gae and the end portion Gbe.

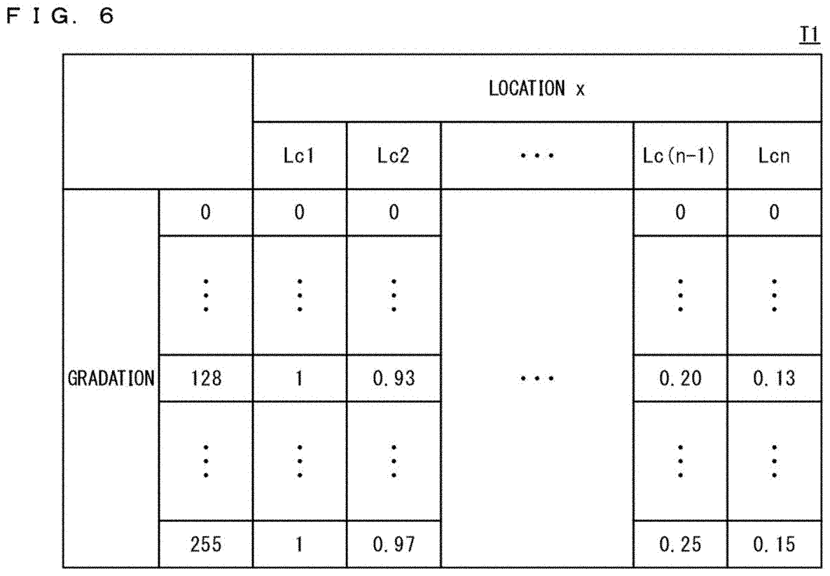

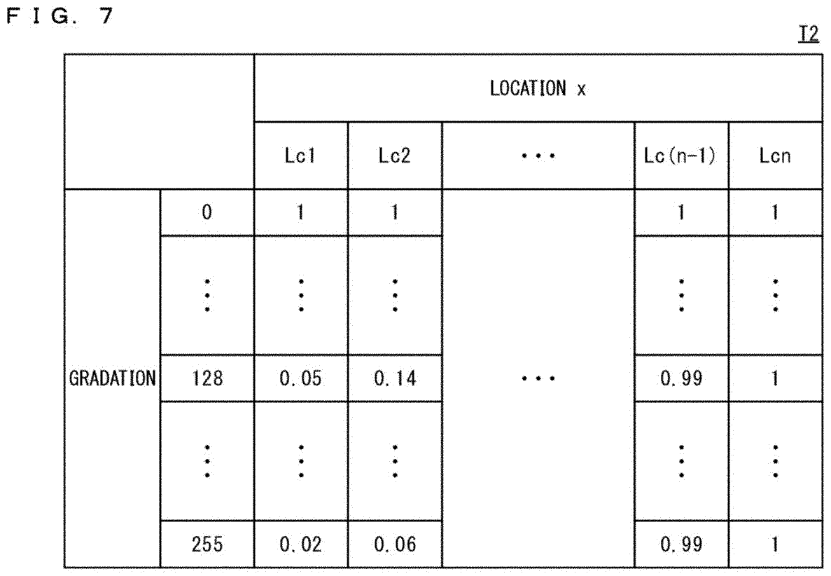

The gradation correction processing is performed, using a correction table T1 in FIG. 6 and a correction table T2 in FIG. 7 as one example. The correction table T1 is a table for correcting the density (gradation values) of each of the pixels of the end portion Gae. The correction table T2 is a table for correcting the density (gradation values) of each of the pixels in the end portion Gbe.

Referring to FIG. 6, the correction table T1 indicates a plurality of coefficients for correcting the densities (gradation values). For each of the coefficients, a value in a range of 0 to 1 is set. The “gradation” in the correction table T1 indicates the gradation value set for each of the pixels (the gradation data). In the correction table T1, the lowest density value as the gradation value is 255. Moreover, in the correction table T1, the highest density value as the gradation value is 0.

A “location x” in the correction table T1 is a location in the overlapping region Rw in the sub-scanning direction. That is, the “location x” is a location of each of the n lines included in the overlapping region Rw. The locations Lc1, Lc2, . . . Lcn are the locations of the n lines.

For example, the location Lc1 is a location of the line closest to the leading end Re1 of the overlapping region Rw of the n lines. Moreover, for example, the location Lcn is a location of the line closest to the rear end Re2 of the overlapping region Rw of the n lines.

The correction table T2 in FIG. 7 is similar to the correction table T1, and thus, detailed description thereof will not be repeated. Since transfer characteristics of the dye differs, depending on the color, the correction tables T1, T2 corresponding to each of Y, M, and C are used. The correction tables T1, T2 are stored in a storage part 3 in advance. As each of the coefficients in the correction tables T1, T2, a proper value is set by repeatedly conducting experiments and the like. The experiments are conducted with respect to the image print processing, change of the coefficient, and the like.

In the following description, each of the pixels included in each of the end portion Gae and the end portion Gbe is also referred to as an “object pixel”. Moreover, in the following description, each of the pixels included in each of the end portion Gar and the end portion Gbr is also referred to as a “correction pixel”. Moreover, in each of the correction tables T1, T2, the coefficient specified by the location x and the gradation value is also referred to as an “object coefficient”.

The correction of the gradation value in the gradation correction processing is performed by multiplying the gradation value of the object pixel by the object coefficient. For example, it is assumed that in the end portion Gae, the gradation value of a certain object pixel in the line existing at the location Lcn is 128. In this case, in the correction table T1 corresponding to the end portion Gae, the object coefficient specified by the location Lcn and the gradation value 128 is 0.13. In this case, the control part 4 sets a value obtained by multiplying 128 by 0.13 as the gradation value of the correction pixel corresponding to the object pixel.

In the gradation correction processing, the above-described correction of the gradation value is performed to the k pixels included in the end portion Gae. In the following description, a Y component of the image is a “Y image”. The Y image is a yellow image. Moreover, in the following description, an M component of the image is also referred to as an “M image”. The M image is a magenta image. Moreover, in the following description, a C component of the image is also referred to as a “C image”. The C image is a cyan image.

Moreover, the above-described correction of the gradation value is performed to the Y image, the M image, and the C image configuring the end portion Gae. This makes the end portion Gae into the end portion Gar.

Moreover, in the gradation correction processing, similarly to the end portion Gae, the correction of the gradation values is performed to the end portion Gbe, using the correction table T2. This makes the end portion Gbe into the end portion Gbr.

In the following description, the image Gwa in which the end portion Gae makes into the end portion Gar by the gradation processing is also referred to as an “image Gwar”. The image Gwar has the end portion Gar. In the following description, the image Gwb in which the end portion Gbe makes into the end portion Gbr by the gradation processing is also referred to as an “image Gwbr”. The image Gwbr has the end portion Gbr. That is, the image Gwar and the image Gwbr are obtained by the gradation processing.

Moreover, in the following description, the heat generated by the thermal head 9 is also referred to as a “thermal energy” or a “transfer energy”. As the density of the pixel for transferring to the paper becomes closer to the highest density, the thermal energy emitted by the thermal head 9 becomes larger. As the density of the pixel for transferring to the paper becomes closer to the lowest density, the thermal energy emitted by the thermal head 9 becomes smaller.

In the following description, a value corresponding to the lowest density is also referred to as a “lowest density value”. For example, the lowest density value in the correction table T1 is 255. Moreover, in the following description, a value corresponding to the highest density is also referred to as a “highest density value”. For example, the highest density value in the correction table T1 is 0.

As the value of the gradation data becomes closer to the highest density value, the required thermal energy becomes larger. Moreover, as the value of the gradation data becomes closer to the lowest density value, the required thermal energy becomes smaller. In the following description, a pixel having a high density corresponding to the large thermal energy is also referred to as a “high density pixel”. In the following description, a pixel having a low density corresponding to the small thermal energy is also referred to as a “low density pixel”.

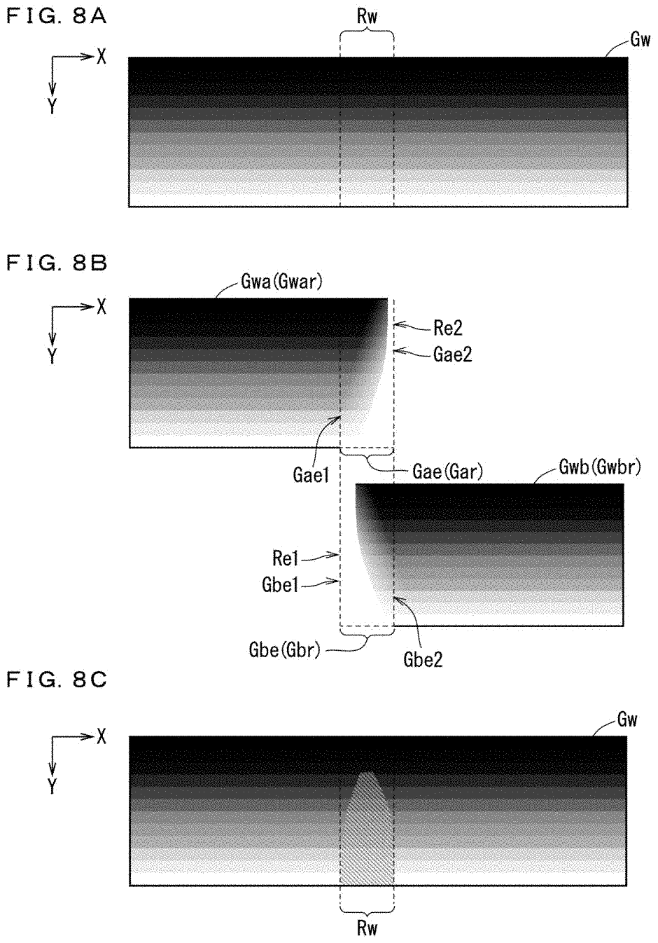

A location where the high density pixel generates a color on the paper is different from a location where the low density pixel generates a color on the paper. Hereinafter, this phenomenon will be described with reference to FIGS. 8A, 8B, and 8C. In the panorama image Gw in FIG. 8A, the density of pixels at an upper end of the panorama image Gw is set to the highest density. In the panorama image Gw in FIG. 8A, the density of pixels at a lower end of the panorama image Gw is set to the lowest density. Moreover, in the panorama image Gw in FIG. 8A, the pixel closer to the lower end of the panorama image Gw has a density closer to the lowest density.

Here, it is assumed that the processing from step S110 to step S130 is performed to the panorama image Gw in FIG. 8A. In this case, the foregoing image Gwar and image Gwbr are obtained by the processing in step S130.

Here, it is assumed that the heat transfer printer 100 performs the image print processing so that the end portion Gbr of the image Gwbr overlaps the end portion of the image Gwar in the overlapping region Rw. In the image print processing, after the image Gwar is formed on the paper 7, the image Gwbr is formed on the paper 7.

In this case, the image Gwar formed on the paper 7 is shown as the image Gwar in FIG. 8B. Moreover, the image Gwbr formed on the paper 7 is shown as the image Gwbr in FIG. 8B. Moreover, the panorama image Gw formed on the paper 7 is shown as the panorama image Gw in FIG. 8C.

As in FIG. 8B, in the end portion Gar, the pixel having a lower density generates the color at a location more distant from the rear end Re2 of the overlapping region Rw. That is, a contour on a rear end Gae2 side of the end portion Gar (Gae) is a curve line. In the following description, the contour on the rear end Gae2 side of the end portion Gar (Gae) is also referred to as a “rear end-side contour”.

As in FIG. 8B, in the end portion Gbr, the pixel having a lower density generates the color at a location more distant from the leading end Re1 of the overlapping region Rw. That is, a contour on a leading end Gbe1 side of the end portion Gbr (Gbe) is a curve line. In the following description, the contour on the leading end Gbe1 side of the end portion Gbr (Gbe) is also referred to as a “leading end-side contour”.

Therefore, if the end portion Gbr in FIG. 8B overlaps the end portion Gar in FIG. 8B in the overlapping region Rw, the nonuniformity as shown in FIG. 8C occurs. As the density of two pixels overlapping each other becomes closer to the lowest density, the nonuniformity more easily occurs.

For example, when as shown in FIG. 8B, the rear end-side contour of the end portion Gar and the leading end-side contour of the end portion Gbr are shown on the paper 7 as the curve lines, the nonuniformity as shown in FIG. 8C easily occurs. That is, there is a problem that in a state where color generation locations of a plurality of pixels along the main scanning direction (Y axis direction) are not fixed at constant locations in the sub-scanning direction as shown in FIG. 8B, density variation of the image print, locational variation of the image print, and the like easily causes unnatural nonuniformity.

Consequently, in order to solve the above-described problem, coefficient change processing is performed in step S140. In the following description, a straight line along the main scanning direction is also referred to as a “straight line Lm”.

In the coefficient change processing, end-corresponding coefficient change processing is performed, the end-corresponding coefficient change processing being for changing the coefficients in the correction tables T1, T2 so that the rear end-side contour of the end portion Gar (Gae), and the leading end-side contour of the end portion Gbr (Gbe) are each shown as the straight line Lm on the paper 7. The end-corresponding coefficient change processing is performed, based on a magnitude of the thermal energy emitted by the thermal head 9 (gradation value).

In the end-corresponding coefficient change processing, for example, in the correction table T1, as the gradation value corresponding to the coefficient becomes closer to the lowest density value (255), a degree of change of the relevant coefficient becomes larger.

In the end-corresponding coefficient change processing, for example, an end-corresponding coefficient change process as an experiment is performed. Specifically, in the end-corresponding coefficient change process, for example, the heat transfer printer 100 prints the image Gwar obtained, based on the correction table T1, and it is confirmed by a worker whether or not the rear end-side contour of the end portion Gar is shown as the straight line Lm on the paper 7. For example, in the case where a part of the rear end-side contour of the end portion Gar is shown as a curve line, the worker performs an operation of changing one or more coefficients corresponding to the relevant curve in the correction table T1, using an information processing apparatus 200. The control part 4 changes the one or more coefficients in the correction table T1 in accordance with the operation.

In the end-corresponding coefficient change processing, the above-described end-corresponding coefficient change process is repeatedly performed until the rear end-side contour of the end portion Gar is shown as the straight line Lm on the paper 7.

The coefficients of the correction table T2 are also changed by a method similar to those of the correction table T1.

In the following description, the correction table T1 the coefficients of which have been changed so that the rear end-side contour of the end portion Gar (Gae) is shown as the straight line Lm on the paper 7 is also referred to as a “correction table T1A”. Moreover, in the following description, the correction table T2 the coefficients of which have been changed so that the leading end-side contour of the end portion Gbr (Gbe) is shown as the straight line Lm on the paper 7 is also referred to as a “correction table T2A”.

In the coefficient change processing, by performing the above-described end-corresponding coefficient change processing, the correction table T1A and the correction table T2A are obtained.

In step S150, gradation processing A is performed. The gradation processing A is different from the gradation processing in that the correction table T1A and the correction table T2A are used in place of the correction table T1 and the correction table T2. Another processing in the gradation processing A is similar to the gradation processing, and thus, detailed description thereof will not be repeated.

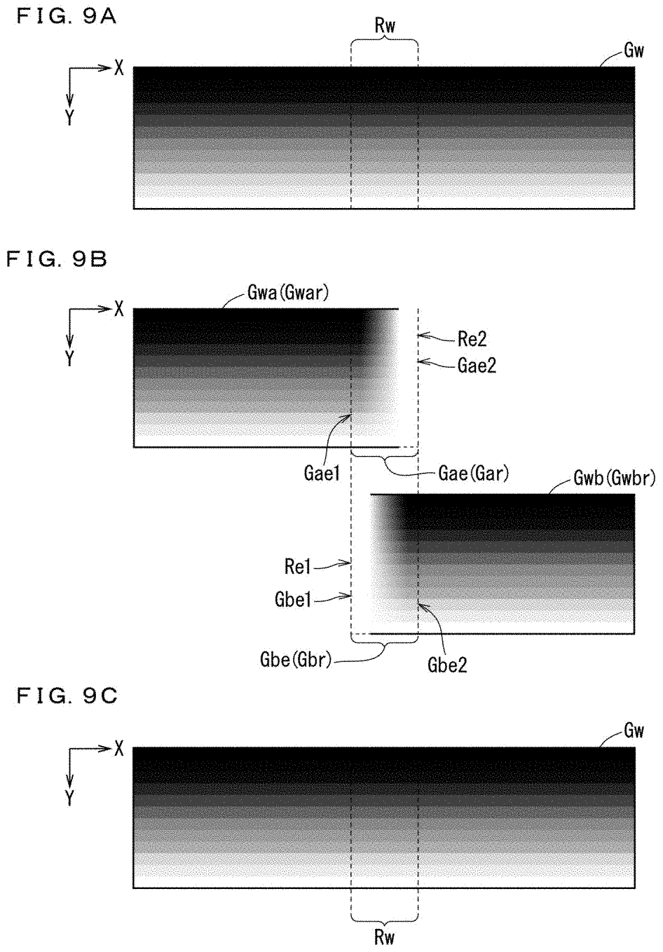

FIGS. 9A, 9B, and 9C are diagrams for describing a state where an image obtained by the gradation processing A is printed. FIG. 9A shows the panorama image Gw. FIG. 9B shows the printed image Gwar and image Gwbr. FIG. 9C shows the panorama image Gw.

The image Gwar (Gae) and the image Gwbr (Gbe) are obtained by the gradation processing A as in the gradation processing. If the image Gwar obtained by the gradation processing A is printed on the paper 7, the rear end-side contour of the end portion Gar (Gae) is shown as the straight line Lm on the paper 7, as shown in FIG. 9B.

Moreover, if the image Gwbr obtained by the gradation processing A is printed on the paper 7, the leading end-side contour of the end portion Gbr (Gbe) is shown as the straight line Lm on the paper 7, as shown in FIG. 9B.

In step S160, image print processing Pw is performed. In the image print processing Pw, the image Gwar and the image Gwbr are printed on the paper 7 in order of the image Gwar and the image Gwbr. In the image print processing Pw, the printing is performed so that the end portion Gbr (Gbe) of the image Gwbr overlaps the end portion Gar (Gae) of the image Gwar in the overlapping region Rw.

In this case, in the image print processing Pw, the control part 4 controls a heat quantity (thermal energy) emitted by the thermal head 9. That is, in the image print processing Pw, the thermal head 9 emits heat in accordance with the control of the control part 4. In the image print processing Pw, when the end portion Gar (Gae) of the image Gwar, and the end portion Gar (Gae) of the image Gwbr are printed, the heat transfer printer 100 performs gradation control processing for forming the end portion Gbr (Gbe) and the end portion Gbr (Gbe) on the paper 7.

In the gradation control processing, when the end portion Gar (Gae) of the image Gwar is printed, heat treatment Ha is performed. That is, the heat treatment Ha is treatment for forming the end portion Gar (Gae) on the paper 7. In the image Gwar, processing for printing a portion other than the end portion Gar (Gae) is general processing, and thus, description thereof will be omitted.

As described before, the end portion Gar of the image Gwar is the end portion Gae in which the density of the end portion Gae gradually decreases from the leading end Gae1 of the end portion Gae toward the rear end Gae2.

Therefore, in the heat treatment Ha, the thermal head 9 emits the heat so that the density of the end portion Gae gradually decreases from the leading end Gae1 toward the rear end Gae2. Moreover, in the heat treatment Ha, further, the thermal head 9 emits the heat so that the contour of the color generation by the ink sheet 6 on the rear end Gae2 side of the end portion Gae is aligned parallel to the main scanning direction. That is, in the heat treatment Ha, the thermal head 9 emits the heat so that the rear end-side contour of the end portion Gae is shown as the straight line Lm on the paper 7.

This allows the rear end-side contour of the end portion Gar (Gae) to be shown as the straight line Lm on the paper 7, as shown in FIG. 9B. That is, on the paper 7, the location of the rear end-side contour of the end portion Gar (Gae), where the color is generated, is a location on the straight line along the main scanning direction (Y axis direction) regardless of the magnitude (gradation value) of the thermal energy.

Moreover, in the gradation control processing, when the end portion Gbr (Gbe) of the image Gwbr is printed, heat treatment Hb is performed. That is, the heat treatment Hb is treatment for forming the end portion Gbr (Gbe) on the paper 7. In the image Gwbr, processing for printing a portion other than the end portion Gbr (Gbe) is general processing, and thus, description thereof will be omitted.

As described before, the end portion Gbr of the image Gwbr is the end portion Gbe in which the density of the end portion Gbe gradually increases from the leading end Gbe1 of the end portion Gbe toward the rear end Gbe2 of the end portion Gbe.

Therefore, in the heat treatment Hb, the thermal head 9 emits the heat so that the density of the end portion Gbe gradually increases from the leading end Gbe1 toward the rear end Gbe2. Moreover, in the heat treatment Hb, further, the thermal head 9 emits the heat so that the contour of the color generation by the ink sheet 6 on the leading end Gbe1 side of the end portion Gbe is aligned parallel to the main scanning direction. That is, in the heat treatment Hb, the thermal head 9 emits the heat so that the leading end-side contour of the end portion Gbe is shown as the straight line Lm along the main scanning direction on the paper 7.

This allows the leading end-side contour of the end portion Gbr (Gbe) to be shown as the straight line Lm on the paper 7, as shown in FIG. 9B. That is, on the paper 7, the location of the leading end-side contour of the end portion Gbr (Gbe) where the color is generated is a location on the straight line along the main scanning direction (Y axis direction) regardless of the magnitude (gradation value) of the thermal energy.

As described above, the rear end-side contour of the end portion Gar (Gae), and the leading end-side contour of the end portion Gbr (Gbe) are each shown as the straight line Lm along the main scanning direction on the paper 7. This can suppress the occurrence of the nonuniformity even if fluctuations of an environment or the like during the image print occur. That is, an action of having robustness against the nonuniformity can be obtained.

Therefore, by performing the above-described image print processing Pw, such an image without nonuniformity as the panorama image Gw in FIG. 9C can be obtained on the paper 7.

As described above, according to the present embodiment, in the heat treatment Ha, the thermal head 9 emits the heat so that the contour of the color generation by the ink sheet 6 on the rear end Gae2 side of the end portion Gae is aligned parallel to the main scanning direction. That is, in the heat treatment Ha, the thermal head 9 emits the heat so that the contour on the rear end Gae2 side of the end portion Gae is shown as the straight line Lm along the main scanning direction on the paper 7.

Moreover, in the heat treatment Hb, the thermal head 9 emits the heat so that the contour of the color generation by the ink sheet 6 on the leading end Gbe1 side of the end portion Gbe is aligned parallel to the main scanning direction. That is, in the heat treatment Hb, the thermal head 9 emits the heat so that the contour on the leading end Gbe1 side of the end portion Gbe is shown as the straight line Lm along the main scanning direction on the paper 7.

This can realize that the contours are shown on the paper as the straight lines along the main scanning direction regardless of the densities of the plurality of pixels configuring the contours of the end portions of the images.

Moreover, according to the present embodiment, when the panorama printing is performed, in the overlapping region Rw, occurrence of a defect (nonuniformity, a border line) or the like of the image can be suppressed. Therefore, the occurrence of the nonuniformity in the density, the color nonuniformity, or the like attributed to the density variation of the image print, the locational variation of the image print, or the like can be suppressed. Accordingly, a panorama image that has an inconspicuous joint of the two images, and is high in printing quality can be obtained.

In each of the related configurations A, B, a joint of two images that exists in an overlapping region is made inconspicuous. However, if the density variation of the image print, the locational variation of the image print, or the like are caused, the defect such as the nonuniformity in the density, the color nonuniformity, or the like occurs. Thus, there is a problem that if the defect occurs, the printing quality decreases.

Consequently, the heat transfer printer 100 of the present embodiment is configured as described above. Thus, the heat transfer printer 100 of the present embodiment can solve the foregoing problem.

### Second Embodiment

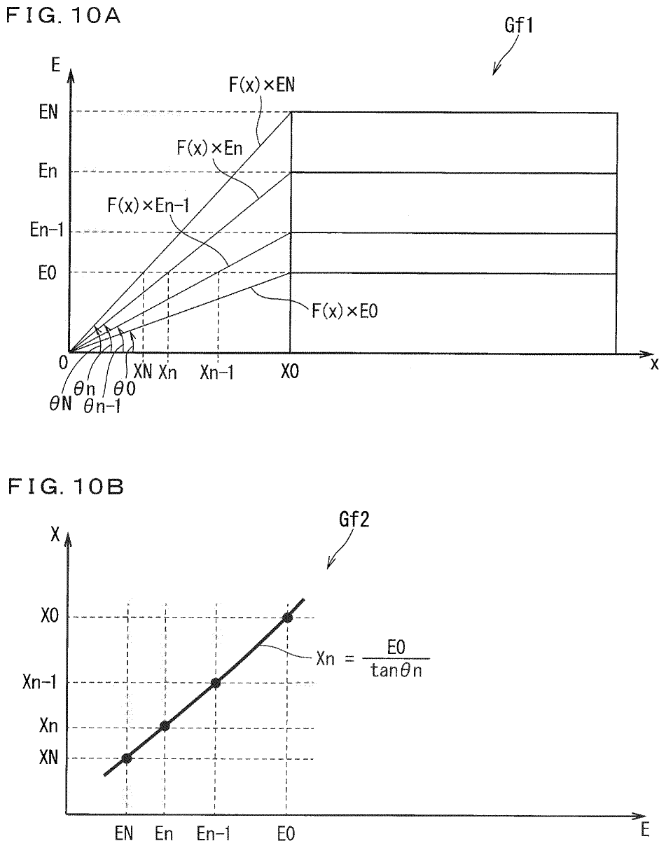

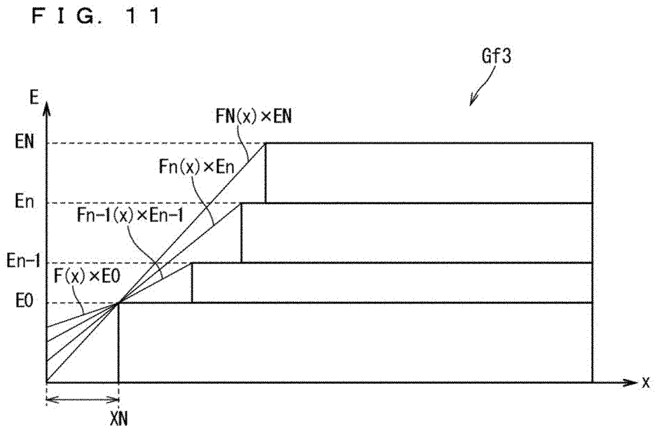

A configuration of the present embodiment is a configuration using a coefficient calculated, based on the thermal energy (hereinafter, also referred to as a “configuration CtA”). First, a relation between the thermal energy and a location where the relevant color dye (ink) is transferred will be described with reference to FIGS. 10A and 10B. As described before, the location of the overlapping region Rw in the sub-scanning direction is represented by a “location x” or “x”. That is, the location “x” corresponds to the location x indicated in the correction table T1, T2.

In the following description, a coefficient used for generating the gradation image is expressed as a “coefficient F(x)” or “F(x)”. As the coefficient F(x), a value in a range of 0 to 1 is set. Moreover, in the following description, the thermal energy emitted by the thermal head 9 is also referred to as a “thermal energy E” or “E”. FIGS. 10A and 10B are diagrams for describing characteristics regarding the thermal energy.

FIG. 10A is a diagram showing a graph Gf1 that expresses the characteristics of the thermal energy E with respect to the location x. The graph Gf1 shows characteristics corresponding to the end portion Gbe of the image Gwb existing the overlapping region Rw. The end portion Gbe is an image existing in the overlapping region Rw. Characteristics corresponding to the end portion Gae of the image Gwa existing in the overlapping region Rw results from inverting the characteristics shown in the graph Gf1 in a right-left direction. Thus, description of the characteristics corresponding to the end portion Gae of the image Gwa will be omitted.

A horizontal axis of the graph Gf1 indicates the location x. A vertical axis of the graph Gf1 indicates the thermal energy E. As the gradation value becomes closer to the highest density value, the thermal energy E corresponding to the relevant gradation value becomes larger. Moreover, as the gradation value becomes closer to the lowest density value, the thermal energy E corresponding to the relevant gradation value becomes smaller. Thus, the thermal energy E has a proportional relation with the gradation value (density).

In the graph Gf1, a location where x is 0 corresponds to the location of the leading end Gbe1 of the end portion Gbe. A location where x is X0 corresponds to the location of the rear end Gbe2 of the end portion Gbe.

A value of the coefficient F(x) at the location 0 is 0. The value of the coefficient F(x) at the location X0 is 1. The coefficient F(x) is a coefficient that takes a value gradually increasing from the location 0 toward the location X0. As the coefficient F(x), for example, values of a plurality of coefficients corresponding to the gradation value 255 in the correction table T2 in FIG. 7 are set.

In the graph Gf1, as one example, E0, En-1, En, EN are shown as values of the thermal energy E. The thermal energy E0 is a lowest value (threshold) necessary for the color dye (ink) to be transferred to the paper 7. That is, the color dye is transferred on the paper 7 by giving a thermal energy (heat) equal to or more than the thermal energy E0 to the relevant color dye.

Moreover, in the graph Gf1, a characteristic line obtained by multiplying the coefficient F(x) by the thermal energy E is indicated. For example, the characteristic line F(x)×EN is a characteristic line obtained by multiplying the coefficient F(x) by the thermal energy EN. For example, since the value of the coefficient F(x) at the location X0 is 1, the thermal energy corresponding to the location X0 is EN.

The location x indicates a location where the color dye is transferred by the thermal energy E. The location where the color dye is transferred is a location where a pixel (color dye) generates the color on the paper 7 (hereinafter, also referred to as a “color generation location”).

According to the graph Gf1, the color generation locations corresponding to the thermal energy E0, En-1, En, EN are locations XN, Xn, Xn-1, X0, respectively. The color generation location corresponding to the thermal energy E0 is a location XN. That is, the color generation location varies, depending on a magnitude of the thermal energy E. Therefore, as described before, in the overlapping region Rw in FIG. 8B, the color generation location of the pixel (high density pixel) corresponding to the large thermal energy E is different from the color generation location of the pixel (low density pixel) corresponding to the small thermal energy E.

In the following description, the color generation location is also referred to a “color generation location X” or “X”. The color generation location X corresponds to the location x in the graph Gf1. A graph in which a horizontal axis is expressed by the thermal energy E, and a vertical axis is expressed by the color generation location X (location X) is a graph Gf2 in FIG. 10B. A relation between E and X is expressed by the following expression 2.

$$\begin{matrix}[ Expression 2 ] & \\ Xn = \frac{E 0}{tan θ n} & ( 2 )\end{matrix}$$

Expression 2 is an expression found, using the thermal energy E0 (threshold value), and an angle formed by E and X. The graph Gf2 shows that the color generation location X varies, depending on the magnitude of the thermal energy. That is, as shown in the graph Gf1 in FIG. 10A, and the graph Gf2 in FIG. 10B, the color generation location varies, depending on the magnitude of the thermal energy. Therefore, the defect (e.g., nonuniformity) described with reference to FIGS. 8B and 8C occurs.

Consequently, in order to prevent the occurrence of the above-described defect, the color generation location varying, depending on the magnitude of the thermal energy needs to be aligned at a constant location, as shown in FIG. 9B. If the color generation location corresponding to a certain thermal energy En is made the same as the color generation location of the thermal energy EN, the following offset dXn needs to be added to the location x (the sub-scanning direction). The offset dXn is a correction value obtained, based on the location x and the thermal energy E.

The offset dXn is, specifically, expressed in the following expression 3.

$$\begin{matrix}[ Expression 3 ] & \\ dXn = \frac{E 0}{tan θ N} - \frac{E 0}{tan θ n} & ( 3 )\end{matrix}$$

The coefficient F(x) with respect to the location x (sub-scanning direction) is decided as a coefficient Fn(x) for each transfer energy En. The coefficient Fn(x) is expressed by the following expression 4, using dXn of expression 3.

[Expression 4]

Fn(x)=F(x+dXn) (4)

As to Fn(x), a relational expression 0.0≤Fn(x)≤1.0 is established. The coefficient Fn(x) is a coefficient calculated, using the offset dXn. The coefficient Fn(x) of expression 4 is a coefficient for showing the leading end-side contour of the end portion Gbr (Gbe) of the image Gwbr as the straight line Lm on the paper 7.

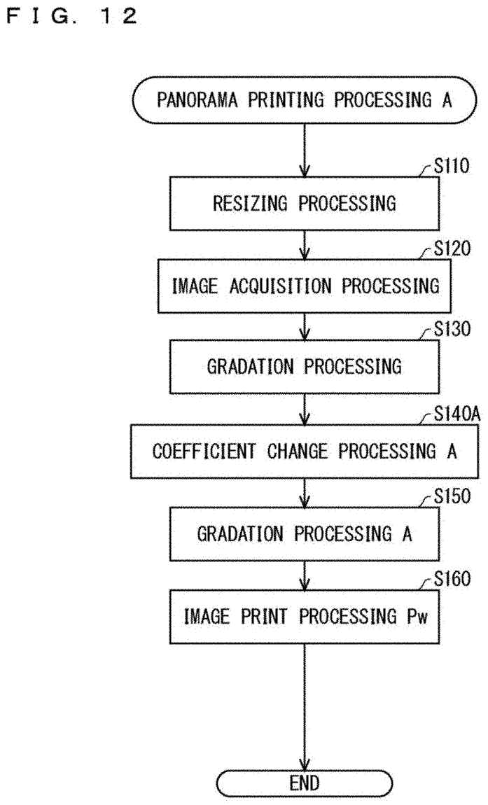

By multiplying the thermal energy En by the coefficient Fn(x) indicated in expression 4, characteristics (Fn(x)×En), which are shown in a graph Gf3 in FIG. 11, are obtained. As a result, as shown inFIG. 9B, the leading end-side contour of the end portion Gbr (Gbe) of the image Gwbr is shown as the straight line Lm along the main scanning direction on the paper 7. That is, on the paper 7, the location of the leading end-side contour of the end portion Gbr (Gbe) where the color is generated is a location on the straight line along the main scanning direction (Y axis direction) regardless of the magnitude (gradation value) of the thermal energy.

In the configuration CtA of the present embodiment, processing using the above-described expressions (hereinafter, also referred to as a “panorama printing processing A”) is performed. FIG. 12 is a flowchart of the panorama printing processing A according to a second embodiment of the present invention. In FIG. 12, in processing in the same step number as the step number in FIG. 5, processing similar to the processing described in the first embodiment is performed, and thus, detailed description thereof will not be repeated. Hereinafter, a description will be given, focusing on different points from the first embodiment.

In the panorama printing processing A, processing in steps S110, S120, S130 is performed as in the first embodiment. After step S130, processing in step S140A is performed.

In step S140A, coefficient change processing A is performed. In the coefficient change processing A, the control part 4 changes the coefficients in the correction tables T1, T2 so that the rear end-side contour of the end portion Gar (Gae), and the leading end-side contour of the end portion Gbr (Gbe) are each shown as the straight line Lm on the paper 7. The change of the coefficients is made, based on the magnitude of the thermal energy E (gradation value).

Here, it is assumed that each of the coefficients indicated in the correction table T2 in FIG. 7 is the coefficient F(x). In this case, the control part 4 changes each of the plurality of coefficients F(x) indicated in the correction table T2 to the coefficient Fn(x) indicated by expressions 4 and 3.

Thereby, the plurality of coefficients indicated in the correction table T2 are changed to the coefficients for showing the leading end-side contour of the end portion Gbr (Gbe) as the straight line Lm along the main scanning direction on the paper 7.

In the following description, the correction table T2 in which the coefficients are changed by the coefficient change processing A is also referred to as a “correction table T2A”. The correction table T2A is a table for showing the leading end-side contour of the end portion Gbr (Gbe) as the straight line Lm on the paper 7.

As described before, the thermal energy E has a proportional relation with the gradation value. Therefore, each of the coefficients Fn(x) indicated in the correction table T2A is a value arithmetically operated by expressions 3 and 4, utilizing the value of the thermal energy E corresponding to the gradation value. For example, in the correction table T2A (correction table T2), the coefficient Fn(x) specified by the gradation value 0 and the location Lc1 is a value arithmetically operated by expressions 3 and 4, utilizing the value of the thermal energy E corresponding to the gradation value 0.

Moreover, in the coefficient change processing A, the control part 4 also changes the plurality of coefficients indicated in the correction table T1 to the coefficients Fn(x) as in the correction table T2. The coefficient Fn(x) used with respect to the correction table T1 is found by expressions derived from a graph resulting from inverting the graph Gf1 in the right-left direction similarly to expressions 2, 3, 4. In the following description, the correction table T1 in which the coefficients are changed by the coefficient change processing A is also referred to as a “correction table T1A”. The correction table T1A is a table for showing the rear end-side contour of the end portion Gar (Gae) as the straight line Lm on the paper 7.

The gradation processing A in step S150, and the image print processing Pw in step S160 are performed as in the first embodiment. The image Gwar (Gae) and the image Gwbr (Gbe) are obtained by performing the gradation processing A. The end portion Gar (Gae) of the image Gwar (Gae) is an image generated, utilizing the coefficient Fn(x) indicated in the correction table T1. Moreover, the end portion Gbr (Gbe) of the image Gwbr (Gbe) is an image generated, utilizing the coefficient Fn(x) indicated in the correction table T2.

In the image print processing Pw, the foregoing gradation control processing (heat treatment Ha and heat treatment Hb) is performed. Therefore, in the panorama printing processing A, the same effects as those in the first embodiment also can be obtained.

As described above, according to the present embodiment, as in the first embodiment, in the overlapping region Rw, the occurrence of the defect (nonuniformity, a border line) or the like of the image can be suppressed. Therefore, the occurrence of the nonuniformity in the density, the color nonuniformity, or the like attributed to the density variation of the image print, the locational variation of the image print, or the like can be suppressed. Accordingly, a panorama image that has an inconspicuous joint of the two images, and is high in printing quality can be obtained.

Moreover, according to the present embodiment, since the coefficient is arithmetically operated, the experiments or the like need not be repeatedly conducted as in the first embodiment. Accordingly, each of the coefficients in the correction tables T1A, T2A can be quickly obtained.

### Third Embodiment

A configuration of the present embodiment is a configuration for adjusting hue of a halftone pixel (hereinafter, also referred to as a “configuration CtB”). The halftone pixel is a pixel having an intermediate gradation value between the lowest density value and the highest density value. The halftone pixel is also referred to as a “gray pixel”. In the following description, the overlapping region Rw is also referred to as a “region Rw”.

Moreover, in the following description, an image inside the region Rw in the image Gwa or the image Gwb is also referred to as an “in-region image”. For example, the in-region image of the image Gwa is the end portion Gae (Gar) (see FIG. 4B). Moreover, in the following description, an image outside the region Rw in the image Gwa or the image Gwb is also referred to as an “out-region image”. For example, the out-region image of the image Gwa is the image Gam (see FIG. 4B).

A color generation sensitivity of the dye to the thermal energy is not constant. Therefore, for example, there is a high possibility that the hue of the halftone pixel included the in-region image of the image Gwar (Gwa), which is obtained by the gradation processing in step S130 in FIG. 5, is different from the hue of the halftone pixel included in the out-region image of the image Gwar (Gwa). In the following description, in the image to be subject to the gradation processing, the hue of the halftone pixel of the relevant image is also referred to as an “original hue”. The original hue is a hue indicated by the halftone pixel not subjected to the image processing.

For example, in a state where the thermal energy given to the color dyes are small, the color generation sensitivity of the dye 6m is smaller than the color generation sensitivities of the dye 6c and the dye 6y. Therefore, in the above-described state, an image generated by the dyes 6y, 6m, 6c becomes a bluish image.

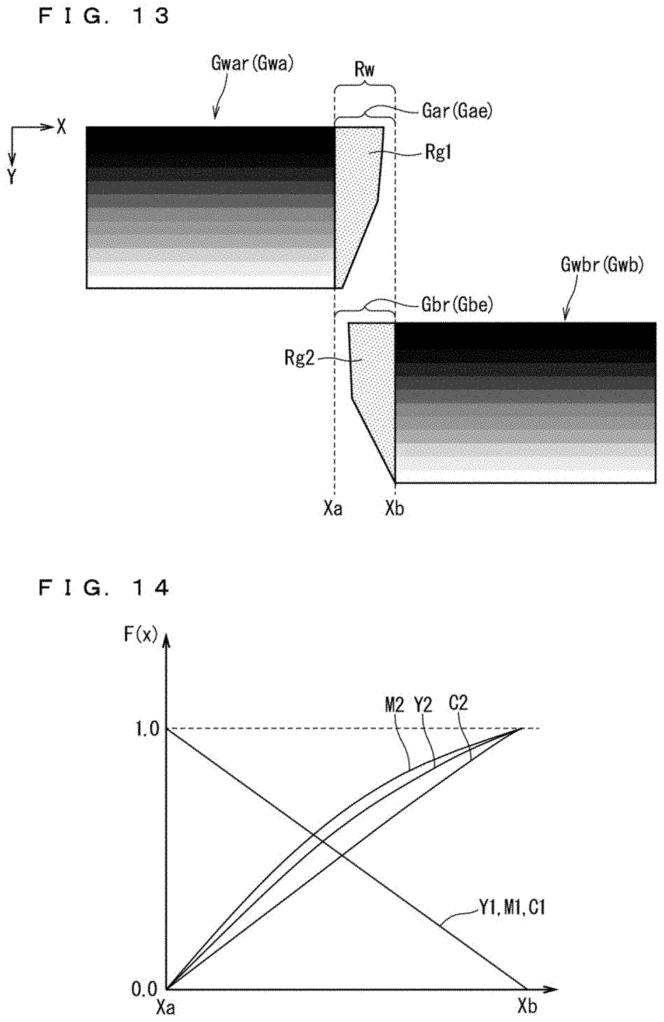

Here, it is assumed that the image Gwar in FIG. 13 is obtained by the gradation processing. In this case, the hue of the halftone pixel inside a region Rg1 (in-region image) of the image Gwar is bluisher than the hue of the halftone pixel in the portion outside the region Rw in the image Gwar. Therefore, the following processing N is generally performed so that in a state where the end portion Gbr of the image Gwbr overlaps the end portion Gar of the image Gwar, the changed hue of the halftone pixel shows the original hue. In the processing N, the hue of the halftone pixel inside a region Rg2 (in-region image) of the image Gwbr in FIG. 13 is changed. The processing N is not processing performed in the configuration CtB in the present embodiment.

In the following description, a characteristic line for adjusting the density (gradation value) of the image is also referred to as a “density adjustment line”. The density adjustment line has a function similar to the foregoing plurality of coefficients indicated in the correction tables T1, T2.

Moreover, in the following description, the density adjustment line for adjusting the density of the Y image is also referred to as an “adjustment line Y”. Moreover, in the following description, the adjustment line Y for adjusting the density of the Y image of the end portion Gae of the image Gwa is also referred to as an “adjustment line Y1” or “Y1”. Moreover, in the following description, the adjustment line Y for adjusting the density of the Y image of the end portion Gbe of the image Gwb is also referred to as an “adjustment line Y2” or “Y2”.

Moreover, in the following description, the density adjustment line for adjusting the density of the M image is also referred to as an “adjustment line M”. Moreover, in the following description, the adjustment line M for adjusting the density of the M image of the end portion Gae of the image Gwa is also referred to as an “adjustment line M1” or “M1”. Moreover, in the following description, the adjustment line M for adjusting the density of the M image of the end portion Gbe of the image Gwb is also referred to as an “adjustment line M2” or “M2”.

Moreover, in the following description, the density adjustment line for adjusting the density of the C image is also referred to as an “adjustment line C”. Moreover, in the following description, the adjustment line C for adjusting the density of the C image of the end portion Gae of the image Gwa is also referred to as an “adjustment line C1” or “C1”. Moreover, in the following description, the adjustment line C for adjusting the density of the C image of the end portion Gbe of the image Gwb is also referred to as an “adjustment line C2” or “C2”.

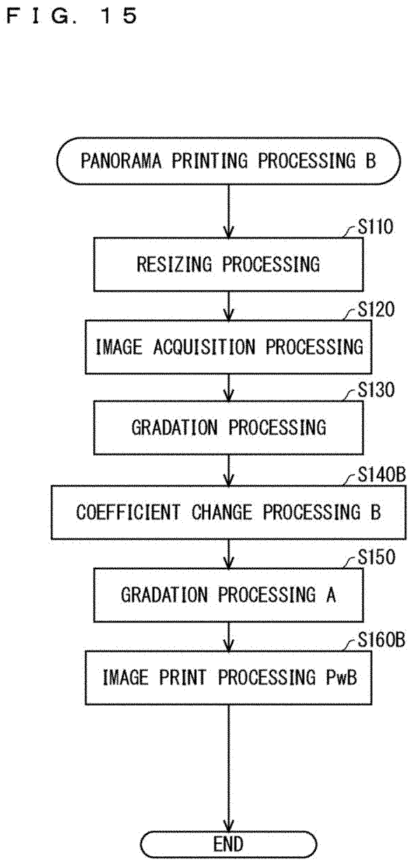

Specifically, in the processing N, the change of the hue of the halftone pixel inside the region Rg2 (region Rw) of the image Gwbr in FIG. 13 is performed, for example, based on FIG. 14. Locations Xa, Xb shown in FIG. 14 correspond to locations Xa, Xb in FIG. 13. Specifically, the adjustment lines M2, Y2, C2 are set as shown in FIG. 14. Thereby, the end portion Gae (Gar), where the density is corrected by the adjustment lines M2, Y2, C2, becomes a reddish image. Thus, by overlapping the reddish end portion Gbr on the bluish end portion Gar, the changed hue of the halftone pixel can exhibit the original hue.

However, there is a problem that in a state where the reddish end portion Gbr is overlapped on the bluish end portion Gar, unnatural nonuniformity easily occurs by the density variation of the image print, the locational variation or the like.

Consequently, in the configuration CtB of the present embodiment, the adjustment of the hue of the halftone pixel is performed. The configuration CtB can be applied to the panorama printing processing in FIG. 5. In the following description, the panorama printing processing in FIG. 5 to which the configuration CtB is applied is also referred to as a “panorama printing processing B”.

FIG. 15 is a flowchart of the panorama printing processing B according to the third embodiment of the present invention. In FIG. 15, in processing in the same step number as the step number in FIG. 5, processing similar to the processing described in the first embodiment is performed, and thus, detailed description thereof will not be repeated. Hereinafter, a description will be given, focusing on different points from the first embodiment.

In the panorama printing processing B, the processing in steps S110, S120, S130 are performed as in the first embodiment. After the processing in step S130, step S140B is performed.

In step S140B, coefficient change processing B is performed. In the coefficient change processing B, hue-corresponding coefficient change processing is performed, the hue-corresponding coefficient change processing being for changing the coefficients in the correction tables T1, T2 so that the hue of the halftone pixel of the in-region image of the image Gwa becomes the same as the hue of the halftone pixel of in-region image of the image Gwb. The hue-corresponding coefficient change processing is also processing for changing the coefficients in the correction tables T1, T2 so that the hue of the halftone pixels of the in-region images of the image Gwa and the image Gwb becomes the same as the hue of the halftone pixels of the out-region images thereof.

Moreover, in the coefficient change processing B, the end-corresponding coefficient change processing is further performed, the end-corresponding coefficient change processing being for changing the coefficients in the correction tables T1, T2 so that the rear end-side contour of the end portion Gar (Gae), and the leading end-side contour of the end portion Gbr (Gbe) are each shown as the straight line Lm on the paper 7.

In the hue-corresponding coefficient change processing, the adjustment of the hue is performed so that the hue of the halftone pixel of the in-region image (region Rg1) of the image Gwar becomes the same as the hue of the halftone pixel of in-region image (region Rg2) of the image Gwbr. That is, the adjustment of the hue is performed so that the hue of the halftone pixel in the region Rg1 of the image Gwar, and the hue of the halftone pixel in the region Rg2 of the image Gwbr show the original hue.

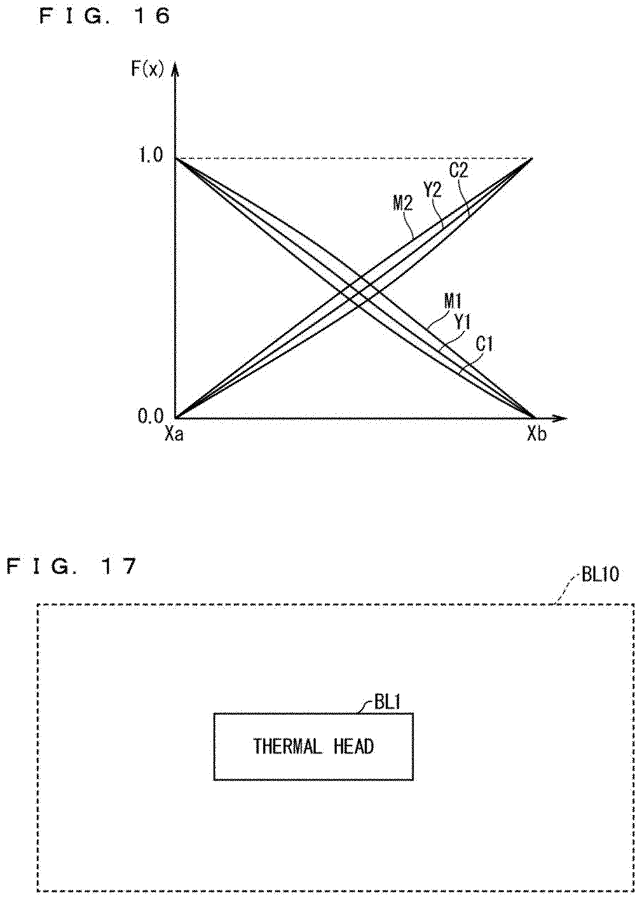

For each of the pixels in the region Rg1 of the image Gwar, the hue is adjusted, for example, using the adjustment lines Y1, M1, C1 adjusted as shown in FIG. 16. For each of the pixels in the region Rg2 of the image Gwbr, the hue is adjusted, for example, using the adjustment lines Y2, M2, C2 adjusted as shown in FIG. 16. The adjustment lines Y1, M1, C1, Y2, M2, C2 are set so that the hue of the halftone pixels shows the original hue.

For example, it is preferable that the adjustment lines Y1, M1, C1, Y2, M2, C2 are adjusted so that in a CIE L*a*b* color space, a relative differential value between coordinate values of a*b* corresponding to the hue and the original hue is three or less. The control part 4 changes the coefficients in the correction tables T1 corresponding to Y, M, C, using the adjustment lines Y1, M1, C1 after the adjustment. Moreover, the control part 4 changes the coefficients in the correction tables T2 corresponding to Y, M, C, using the adjustment lines Y2, M2, C2 after the adjustment.

The hue-corresponding coefficient change processing may be performed by a method other than the above-described method. For example, in the hue-corresponding coefficient change processing, a hue-corresponding coefficient change process as an experiment may be performed. In the relevant hue-corresponding coefficient change process, for example, the heat transfer printer 100 prints the image Gwar obtained by the correction table T1, and a color measuring apparatus or the like measures the hue of the halftone pixel in the end portion Gar. If the hue of the halftone pixel is different from the original hue, an operation is performed by the worker, using the information processing apparatus 200, the operation changing the coefficients in the correction table T1 so that the hue of the halftone pixel is close to the original hue. The control part 4 changes the coefficients in the correction table T1 in accordance with the operation. In the hue-corresponding coefficient change processing, the hue-corresponding coefficient change process is repeatedly performed till the hue of the halftone pixel becomes the original hue.

The coefficients of the correction table T2 are also changed by a method similar to that of the correction table T1.

Moreover, in the coefficient change processing B, the foregoing end-corresponding coefficient change processing is further performed as in the first embodiment. Description of the end-corresponding coefficient change processing will be omitted.

In the following description, the correction table T1 in which the coefficients are changed by the hue-corresponding coefficient change processing and the end-corresponding coefficient change processing is also referred to as the “correction table T1A”. Moreover, in the following description, the correction table T2 in which the coefficients are changed by the hue-corresponding coefficient change processing and the end-corresponding coefficient change processing is also referred to as the “correction table T2A”.

The correction tables T1A, T2A are tables for making the hue of the halftone pixel in the in-region image of the image Gwa and the hue of the halftone pixel in the in-region image of the image Gwb. Moreover, the correction tables T1A, T2A are also tables for making the hue of the halftone pixels in the in-region images of the image Gwa and Gwb and the hue of the halftone pixels in the out-region images thereof the same.

Moreover, the correction table T1A is also a table for showing the rear end-side contour of the end portion Gar (Gae) as the straight line Lm on the paper 7. Moreover, the correction table T2A is also a table for showing the leading end-side contour of the end portion Gbr (Gbe) as the straight line Lm on the paper 7.

The gradation processing A in step S150 is performed as in the first embodiment. Next, step S160B is performed.

In step S160B, image print processing PwB is performed. The image print processing PwB is different from the image print processing Pw in step S160 in contents of the heat treatment Ha and the heat treatment Hb. Another processing of the image print processing Pwb is similar to that of the image print processing Pw, and thus, detailed description thereof will not be repeated.

In the image print processing PwB, the heat treatment Ha and the heat treatment Hb are performed in the gradation control processing as in the image print processing Pw. In the heat treatment Ha, the thermal head 9 emits the heat so that the contour of the color generation by the ink sheet 6 on the rear end Gae2 side of the end portion Gae is aligned parallel to the main scanning direction. That is, in the heat treatment Ha, the thermal head 9 emits the heat so that the rear end-side contour of the end portion Gae is shown as the straight line Lm on the paper 7.

In the heat treatment Hb, the thermal head 9 emits the heat so that the contour of the color generation by the ink sheet 6 on the leading end Gbe1 side of the end portion Gbe is aligned parallel to the main scanning direction. That is, in the heat treatment Hb, the thermal head 9 emits the heat so that the leading end-side contour of the end portion Gbe is shown as the straight line Lm along the main scanning direction on the paper 7.

Moreover, in the heat treatment Ha and the heat treatment Hb of the image print processing PwB, further the thermal head 9 emits the heat so that the hue of the halftone gradation of the end portion Gae becomes the same as the hue of the halftone gradation of the end portion Gbe.

As described above, according to the present embodiment, the rear end-side contour of the end portion Gar (Gae), and the leading end-side contour of the end portion Gbr (Gbe) are each shown as the straight line Lm along the main scanning direction on the paper 7. Therefore, as in the first embodiment, in the overlapping region Rw, the occurrence of the defect (nonuniformity, a border line) or the like of the image can be suppressed. Therefore, the occurrence of the nonuniformity in the density, the color nonuniformity or the like attributed to the density variation of the image print, the locational variation of the image print or the like can be suppressed. Accordingly, a panorama image that has an inconspicuous joint of the two images, and is high in printing quality can be obtained.

Moreover, according to the present embodiment, the hue of the halftone gradation of the end portion Gae becomes the same as the hue of the halftone gradation of the end portion Gbe. Moreover, the hue of the halftone pixels in the in-region images of the image Gwa and Gwb becomes the same as the hue of the halftone pixels in the out-region images thereof. Therefore, in the overlapping region Rw, the occurrence of the defect (nonuniformity, a border line) or the like of the image can be suppressed.

Moreover, according to the present embodiment, the occurrence of the nonuniformity can be suppressed even if fluctuations of an environment or the like during the image print occur. That is, an action of having robustness against the nonuniformity can be obtained.

A configuration may be employed in which the hue-corresponding coefficient change processing is further performed immediately before the coefficient change processing A in step S140A in FIG. 12 in the second embodiment (hereinafter, also referred to as a “configuration CtBa”). In the configuration CtBa, after the processing in step S130, the hue-corresponding coefficient change processing is performed, and the coefficient change processing A in step S140A is performed. That is, in the configuration CtBa, the coefficient change processing A in step S140A is performed to the correction tables T1, T2 in which the coefficients have been changed by the hue-corresponding coefficient change processing.

(Functional Block Diagram)

FIG. 17 is a block diagram showing a characteristic functional configuration of a heat transfer printer BL10. The heat transfer printer BL10 corresponds to the heat transfer printer 100. That is, FIG. 17 is a block diagram showing a main function according to the present invention of the functions that the heat transfer printer BL10 has.

The heat transfer printer BL10 forms a synthetic image expressed by a first image and a second image on paper by a thermal head BL1 heating an ink sheet.

The synthetic image has an overlapping region where a first end portion overlaps a second end portion, the first end portion being a rear end portion of the first image, and the second end portion being a leading end portion of the second image. The first end portion has a first leading end and a first rear end, the first leading end corresponding to a leading end of the overlapping region, and the first rear end being a rear end of the first image. The second end portion has a second leading end and a second rear end, the second leading end being a leading end of the second image, and the second rear end corresponding to a rear end of the overlapping region.

The heat transfer printer BL10 functionally includes the thermal head BL1. The thermal head BL1 emits heat. The thermal head BL1 corresponds to the thermal head 9.

The heat transfer printer BL10 performs gradation control processing for forming the first end portion and the second end portion on the paper. In the gradation control processing, first heat treatment and second heat treatment are performed.

In the first heat treatment, the thermal head BL1 emits heat so that a density of the first end portion gradually decreases from the first leading end toward the first rear end, and that a contour of color generation by the ink sheet on a first rear end side of the first end portion is aligned parallel to a main scanning direction.

In the second heat treatment, the thermal head BL1 emits the heat so that a density of the second end portion gradually increases from the second leading end toward the second rear end, and that a contour of the color generation by the ink sheet on a second leading end side of the second end portion is aligned parallel to the main scanning direction.

<Other Modifications>

While in the foregoing, the heat transfer printers according to the present invention have been described based on the respective embodiments, the present invention is not limited to the respective embodiments. The present invention includes a technique resulting from applying, to the respective embodiments, modifications that a person skilled in the art conceives within a range not departing from the gist of the present invention. That is, in the present invention, within the scope of the invention, each of the embodiments can be freely combined, or each of the embodiments can be appropriately modified or omitted.

For example, a part of the panorama printing processing in FIG. 5, a part of the panorama printing processing A in FIG. 12, and a part of the panorama printing processing B in FIG. 15 may be performed by the information processing apparatus 200 in place of the control part 4 of the heat transfer printer 100.

For example, all or a part of the processing in steps S110 to S150 of the panorama printing processing in FIG. 5 may be performed by the information processing apparatus 200. The information processing apparatus 200 may transmit the data of the image obtained in step S150 to the heat transfer printer 100, and the heat transfer printer 100 may perform the processing in step S160.

Moreover, for example, all or a part of the processing in steps S110 to S150 of the panorama printing processing A in FIG. 12 may be performed by the information processing apparatus 200. The information processing apparatus 200 may transmit the data of the image obtained in step S150 to the heat transfer printer 100, and the heat transfer printer 100 may perform the processing in step S160.

Moreover, for example, all or a part of the processing in steps S110 to S150 of the panorama printing processing B in FIG. 15 may be performed by the information processing apparatus 200. The information processing apparatus 200 may transmit the data of the image obtained in step S150 to the heat transfer printer 100, and the heat transfer printer 100 may perform the processing in step S160B.

Moreover, for example, while in each of the above-described embodiments, the number of the images used in the configuration of the panorama image Gw is two, the number may be three or more.

Moreover, the heat transfer printer 100 may not include all the components shown in the figures. That is, the heat transfer printer 100 only need to include minimum components that can realize the effects of the present invention.

Although the present invention has been described in detail, the above description is illustrative in all aspects, and the present invention is not limited thereto. It is understood that innumerable modifications not illustrated can be envisaged without departing from the scope of the present invention.

### EXPLANATION OF REFERENCE SIGNS

6: ink sheet
7: paper
9, BL1: thermal head
100, BL10: heat transfer printer

1. A heat transfer printer that forms a synthetic image expressed by a first image and a second image on paper by a thermal head heating an ink sheet,
wherein the synthetic image has an overlapping region where a second end portion overlaps a first end portion, the first end portion being a rear end portion of the first image, and the second end portion being a leading end portion of the second image,
the first end portion has a first leading end and a first rear end, the first leading end corresponding to a leading end of the overlapping region, and the first rear end being a rear end of the first image,
the second end portion has a second leading end and a second rear end, the second leading end being a leading end of the second image, and the second rear end corresponding to a rear end of the overlapping region,
the heat transfer printer comprises
the thermal head that emits heat,
the heat transfer printer performs gradation control processing for forming the first end portion and the second end portion on the paper,
in the gradation control processing, first heat treatment and second heat treatment are performed,
in the first heat treatment, the thermal head emits the heat so that a density of the first end portion gradually decreases from the first leading end toward the first rear end, and that a contour of color generation by the ink sheet on a first rear end side of the first end portion is aligned parallel to a main scanning direction regardless of the magnitude of the thermal energy, and
in the second heat treatment, the thermal head emits the heat so that a density of the second end portion gradually increases from the second leading end toward the second rear end, and that a contour of the color generation by the ink sheet on a second leading end side of the second end portion is aligned parallel to the main scanning direction regardless of the magnitude of the thermal energy.

2. The heat transfer printer according to claim 1,
wherein the first heat treatment is treatment for forming the first end portion on the paper, the first end portion being generated, utilizing a coefficient calculated using a correction value obtained, based on a location in a sub-scanning direction of the overlapping region, and a thermal energy emitted by the thermal head, and
the second heat treatment is treatment for forming, on the paper, the second end portion generated utilizing the coefficient.

3. The heat transfer printer according to claim 1, wherein in the first heat treatment and the second heat treatment, further, the thermal head emits the heat so that hue of halftone gradation of the first end portion becomes the same as the hue of the halftone gradation of the second end portion.

4. A printing control method performed by a heat transfer printer that forms a synthetic image expressed by a first image and a second image on paper by a thermal head heating an ink sheet,
wherein the synthetic image has an overlapping region where a second end portion overlaps a first end portion, the first end portion being a rear end portion of the first image, and the second end portion being a leading end portion of the second image,
the first end portion has a first leading end and a first rear end, the first leading end corresponding to a leading end of the overlapping region, and the first rear end being a rear end of the first image,
the second end portion has a second leading end and a second rear end, the second leading end being a leading end of the second image, and the second rear end corresponding to a rear end of the overlapping region,
the printing control method comprises a gradation control step for forming the first end portion and the second end portion on the paper,
in the gradation control step, first heat treatment and second heat treatment are performed,
in the first heat treatment, the thermal head emits the heat so that a density of the first end portion gradually decreases from the first leading end toward the first rear end, and that a contour of color generation by the ink sheet on a first rear end side of the first end portion is aligned parallel to a main scanning direction regardless of the magnitude of the thermal energy, and
in the second heat treatment, the thermal head emits the heat so that a density of the second end portion gradually increases from the second leading end toward the second rear end, and that a contour of the color generation by the ink sheet on a second leading end side of the second end portion is aligned parallel to the main scanning direction regardless of the magnitude of the thermal energy.
